(19) United States
(12) Patent Application Publication
(10) Pub. No.: US 2003/0002297 A1
(43) Pub. Date: Jan. 2, 2003

(54) Light bracelet and brace

(76) Inventor: Igor Z. Nemtsev, Bellevue, WA (US)

Correspondence Address: Ingrid T. Fuhriman, 13910 SE 23rd Street, Bellevue, WA, 98005, US

(21) Appl. No.: 10/174,657

(22) Filed: Jun. 19, 2002

Related U.S. Application Data
(60) Provisional application No. 60/300,722, filed on Jun. 26, 2001.

(51) Int. Cl. F21V 21/08

(52) U.S. Cl. 362/571; 362/104

(57) ABSTRACT

This invention incorporates either LEDs or Laser diodes or both into a large watch-case or small box (Light Module) that can be either worn as a bracelet (See FIG. 1) or brace (See FIG. 2). These LEDs and Laser diodes are controlled by microprocessor(s), which determines the following: wavelength, power level, energy, and pulse frequency. The device can be powered either by batteries or power plug.

The device may incorporate either a permanent or electric magnet to further enhance the therapeutic effects. The permanent magnets are interchangeable, while the strength of the electric magnet is adjustable relative to the wavelength, power level, pulse frequency, and also patient life condition or treatment area.

### CROSS-REFERENCE TO RELATED APPLICATIONS

This is a continuation of a co-pending U.S. Provisional Patent Application:

Serial No. 60,300,722

Filed on: Jun. 20, 2001

### STATEMENT REGARDING FEDERALLY SPONSORED RESEARCH OR DEVELOPMENT

“N/A”

### REFERENCE TO SEQUENCE LISTING, A TABLE, OR A COMPUTER PROGRAM LISTING COMPACT DISC APPENDIX

“N/A”

### BACKGROUND OF THE INVENTION

1. Field of the Invention

This invention is based on Dr. Nemtsev's research and knowledge of lasers in the former Soviet Union.

Laser Therapy is the application of red and near infra-red light, from LEDs or Laser diodes over injuries or lesions to improve wound and soft tissue healing and provide relief to both acute and chronic pain. It improves the overall immune functions. Laser Therapy is officially referred to as “Low Level Laser Therapy” or LLLT.

2. Problem: Back Ground on Pain Management, Healing, Detoxification, and Immune Function

The Department of Defense (DoD) is in pursuit of developing novel medical technology that allows the individual soldier to overcome acute battlefield injuries in an austere and isolated environment. Statistics show that relatively minor injuries are responsible for nearly 66% of combat casualties in the battlefield. Nonetheless, even these minor injuries often lead to evacuation, which compromises the unit and can lead to mission failure. Hemorrhage accounts for 40% of deaths in the battlefield.

There is a tremendous lack in medical devices that allow the individual soldier to stabilize his injury and overcome his immediate need for classical medical care, which would result in a reduction in morbidity and mortality in the battlefield, and an increase in soldier persistence. These devices must have diagnostic and therapeutic capabilities to allow non-medic soldiers to overcome operational combat hazards from conventional munitions, laser weapons, chemical weapons and radiation. Ultimately these technologies must be light enough to carry in a backpack, or incorporated into the soldier's Battle Dress Uniform (BDU).

Pain is a problem to mankind generally (as well as to soldiers on the battlefield) and everyone responds differently to pain. As pain is highly individualized and subjective, the soldier that is actually experiencing the pain is the only authority on that particular pain. Pain management, though constantly improving, remains suboptimal in some respects due to both inadequacies of health care delivery and in the range of available drugs and devices and other therapeutic modalities.

The Wound Healing process is a complex series of events that begins at the moment of injury and can continue for months to years. Stage 1 is the “Inflammatory Phase”, Stage 2 is the “Proliferative Phase”, and Stage 3, the “Remodeling Phase”. Wound contamination and infection poses the highest treat to soldiers on and off the battlefield. A contaminated wound will heal, an infected wound will not. Although all wound exudate contains bacteria killing enzymes that will help prevent an infection, proper cleansing, debridement and maintaining of a moist wound environment on the battlefield is less than optimal.

Detoxification: As the threat of both chemical and biological weapon use in the battlefield increases, there is a great need in both protection and treatment. Military chemical agents currently know to exist fall into seven groups. The modern agents are toxins, defoliants, nerve agents, incapacitating agents, and psychological agent, but older substances such as blister and chocking agents are still available on the market. Although most agents are treatable, but unless the individual soldier receives immediate care right there and than on the battlefield, there is little chance of full recovery. A consideration frequently overlooked is that no attempt has been made to supply NBC clothing to the civilian population at large.

In the civilian as well as the military population, intoxication w/drugs & alcohol as well as hazardous chemical exposure in the home, office or workplace continue to present serious problems health problems.”

3. Description of the Related Art

There are many laser therapy devices out on the market, being manufactured by companies all over the world. However, most of the device manufacturers are located in Europe and Asia, with little or no market representations in the United States. Medical laser manufacturers in the US are mainly into surgical and cosmetic lasers.

Please note: None of the LLLT or LED therapy devices out on the market are wearable or applied with either a permanent or electric magnet.

US Patent Documents in the Related Art:

| | | |
|---|---|---|
| 5,464,436 | Nov., 1995 | Smith |
| 5,616,140 | Apr., 1997 | Prescott |
| 5,693,049 | Dec., 1997 | Mersch |
| 5,865,840 | Feb., 1999 | Chen |
| 6,063,108 | May, 2000 | Salansky at al. |
| 6,156,028 | Dec., 2000 | Prescott |
| 6,267,779 | Jul., 2001 | Gerdes |
| 6,302,900 | Oct., 2001 | Riggs |

### 4. OTHER REFERENCES

1. “15 Years Experience of Low Energy Lasers Applications for Patients Treatment in Emergency Care Clinics,” by Nemtsev, Proceedings SPIE, Vol. 2100, 1994, pp 284-291

2. “Photochemotherapy in Clinical and Veterinary Medicine: Therapeutic Effects and Mechanisms,” by Samoilova et al., Journal of Low Level Laser Therapy and Photobioactivation, Abstracts: WALT 1996, Vol. 8, No 1, April 1996

3. “Our Experience in the Use of Low Intensity Helium-Neon Laser in the Treatment of Acute Myocardial Infarction,” by Kipshidze et al., Journal of Low Level Laser Therapy and Photobioactivation, Abstracts: WALT 1996, Vol. 8, No 1, April 1996

4. “The Mechanisms of Action of Extracorporel Helium-Neon Laser Irradiation in Acute Exogenous Poisonings,” by Nemtsev et al., Journal of Anesthesiology and Reanimation, No A September, 1997, pp 33-35

5. “Mechanisms of Low-Power Laser Light Action on Cellular Level,” by Karu, Proceedings SPIE, Vol. 4159, 2000, pp 284-291, pp 1-17

### BRIEF SUMMARY OF THE INVENTION

This invention incorporates either LEDs or Laser diodes or both into a large watch-case or small box (Light Module) that can be either worn as a bracelet (See FIGS. 6 & 7) or brace (See FIG. 8). These LEDs and Laser diodes are controlled by microprocessor(s), which determines the following: wavelength, power level, energy, and pulse frequency. The device can be powered either by batteries or power plug.

Preprogrammed and programmable light therapy procedures rebalance blood and normalize immune system characteristics by activating oxygen dissolved in blood and or other photomodulation effects beneficial to the body. The device is capable of reducing pain, accelerating wound healing, and detoxifying blood.

The Light Module can also be connected to a computer or life support system, which can control and adjust the various amplitudes according to the patient's life conditions.

The device may also incorporates either a permanent or electric magnet to further enhance the therapeutic effects. The permanent magnets are interchangeable, while the strength of the electric magnet is adjustable relative to the wavelength, power level, pulse frequency, and also patient life condition or treatment area.

### DETAILED DESCRIPTION OF THE INVENTION

1. Light Therapy by Laser or LED

Laser Therapy is the application of red and near infra-red light over injuries or lesions to improve wound and soft tissue healing and give relief for both acute and chronic pain. Laser Therapy is officially referred to as “Low Level Laser Therapy” or LLLT.

Laser Therapy is used to:

1) Increase the speed, quality and tensile strength of tissue repair

2) Give pain relief

3) Resolve inflammation

4) An alternative to needles for acupuncture

The red and near infrared light (600 nm-1000 nm) can be produced by laser or high intensity LED. The intensity of LLLT lasers and LED's is not high like a surgical laser, there is no heating effect. LLLT devices are typically delivering 5 mW-1000 mW (0.2->0.01 Wafts). The power density typically ranges from 0.05W/Cm2->5 W/Cm2.

LLLT aims to biostimulate. Because of the low power nature of the LLLT, the effect is photochemical (like photosynthesis in plants) and not thermal and can not cause heating and thereby cause damage to living tissues. Four distinct effects are known to occur when using LLLT (See FIGS. 9 & 10):

A. Growth factor response within cells and tissue as a result of increased ATP and protein synthesis; Improved cell proliferation; Change in cell membrane permeability to calcium up-take.

B. Pain relief as a result of increased endorphin release; Increased serotonin; Suppression of nociceptor action.

C. Strengthening the immune system response via increasing levels of lymphocyte activity and through a newly researched mechanism termed photomodulation of blood.

D. Acupuncture point stimulation

2. Photomodulation

The effects of the photomodulation are associated with the generation of singlet oxygen in blood (See FIG. 10). Singlet oxygen dissolved in blood is very unstable and when deactivated, it activates surrounding water dipoles.

Water activation near the membrane causes membrane depolarization. Membrane depolarization process causes various treatment effects. One of them is cell membrane receptor cleaning from attached polarized toxin groups. If an immune-competent cell is cleaned, a functional activity of different immune receptors improves. This effect is known as priming effect of immune-competent cells.

A good example of this effect would be when there are toxins present in the blood stream. The polarized toxins tend to attach themselves to the Red Blood Cells (RBC), causing a decrease in its capability to carry oxygen (O₂) to the vital parts of the body amongst other functions. The photomodulation effects caused by the LLLT will depolarize the RBC and thus cause the toxins and other radicals to repel from it, thereby greatly improving its abilities to function properly.

3. Light Module Parameters

The invention: Light Bracelet and Brace, will utilize the following parameters to achieve the best possible therapeutic effects for: Pain Management, Wound Healing, and Detoxification.

A. Selection of the correct beneficial “Wavelength”

B. The use of the correct “Power levels”

C. The consistent application of the necessary amount of “Energy”

D. And different “Pulsing Frequency”

A. Wavelength: The invention will utilize both red light and infrared in the following parameters: (See FIG. 11)

Red Light=620-675 nm

Infrared=780-1200 nm

The benefits of “Red Light” in these wavelengths are: 1) The wavelengths in this spectrum are readily absorbed by the mitochondria and therefore potentially stimulatory; 2) It is an excellent source of stimulation of growth factors; 3) Does not penetrate deep below the skin surface and into the tissue below; 4) Non-thermal, does not cause any burns; 5) Best for wound healing.

The benefits of “Infrared” in these wavelengths are: 1) Absorbed through the cell walls (acting differently between cells) and therefore cell response is more wavelength specific in the infrared range, responding differently to different wavelengths; 2) More penetrative through the tissue, especially the 800 nm range, therefore this range is best for treatment through intact skin and pain relief.

B. Power: The invention will use the following power strengths in its devices: 10 mW-200 mW (0.2->0.01 Watts). The power density will range from 0.05W/Cm2->5 W/Cm2.

C. Energy: The energy level in measured in “Jules” with the simple formula: Energy=Power×Time. The devices of the invention will utilize a special timing circuit that will automatically calculate the energy according the power level and wavelength and adjust the exposure time accordingly.

D. Pulsing Frequency: Our research has shown that there are specific frequencies that are effective in pain management, wound healing, detoxification, and other treatments.

4. Magnet Parameters

When a magnetic field is placed against the body, bio-electric activity occurs. What happens at a cellular level is that trace elements of iron and potassium in the blood are drawn to the resulting magnetic field, causing a mild constricting effect in the blood stream.

Red blood cells are drawn to the affected areas, increasing lymphatic drainage and helping to remove the blockages. This means that damaged tissue can repair which, in turn, allows the inflamed capillaries to dilate. This removes tension from the nerve endings, which cease to be aggravated. The results of the applied magnetic field are: pain relief, plus a restoration of electron flow in the body.

The strength of the magnet is rated against the earth's natural magnetic field, which is 0.5 gauss. Both the permanent and electric magnet in the invention will be in the following gauss range:

| | |
|---|---|
| Permanent Magnet: | 200-20,000 Gauss |
| Electric Magnet: | 200-10,000 Gauss |

5. Integrated Light Module

A. General Description: The “Integrated Light Module” is the unit that contains all the vital components of the therapy device. Including all; control circuitry, either LEDs or Laser diodes or both, diodes reflector prisms, either permanent or electric magnets, mini heat sink, batteries (or other power cells), LCD or LEDs readouts, control adjustment buttons, data communications port, and power plug port. (See FIGS. 1 & 2)

B. Module Control Configuration: The light module and be manufactured with any of the following configurations:

1) With LCD Readouts (See FIG. 3)

2) Without Readouts (See FIG. 4)

3) With LED readouts (See FIG. 5)

C. Module Models: The light module can utilize either LEDs or Laser Diodes, or both as the light therapy source (See FIGS. 1 & 2).

LED or Mix Model: (See FIG. 1) In this model, one to twelve or more LEDs and or Laser Diodes are placed vertically down, directly above the emission window, with a mini heat sink attached above the diode circuit board to transport the excess heat to the side of the casing. The microprocessor control unit controls the different parameters of the module, while the diode drive circuit regulates the power going to the diodes. The permanent or electric magnet(s) are placed or lined around the emission window like a donut and can be changed or removed via the compartment cover located on the bottom of the module. A data cable can be plugged into the data port and connect the module to a computer which monitors the patient's vital life signs and adjusts the different parameters accordingly. The module can be powered by its onboard batteries or can be plugged in through its power plug port.

Laser Diode Model: (See FIG. 2) In this model, one to eight or more laser diodes are mounted horizontally in the module with a reflector prism to direct the horizontal laser emission vertically downwards towards the target treatment area, this is due to the length of the diodes used. A mini heat sink is placed above the laser diodes to transport excess heat to the side of the casing. The permanent or electric magnet(s) are placed Or lined around the emission window like a donut and can be changed or removed via the compartment cover located on the bottom of the module. A data cable can be plugged into the data port and connect the module to a computer which monitors the patient's vital life signs and adjusts the different parameters accordingly. The module can be powered by its onboard batteries or can be plugged in through its power plug port.

D. Bracelet Configuration:

General Description: The invention or StarLight™ bracelet is a wearable LLLT (either LEDs or Laser Diodes) & magnetic device that goes over the wrist just like a watch. This unit targets the arteries and veins underneath the wrist and can be used daily to treat or enhance a number of different bodily functions, such as: carp tunnel, arthritis, increase ATP and protein synthesis and also calcium up-take for patients with osteoporoses and strengthening of the immune system through our proprietary photomodulation of blood.

The unit has a large LCD displace, giving clear and accurate readouts to the user. The inner straps are made of soft elastomer, making the fit firm yet comfortable over long periods of time. The unit is powered either by its internal power cells or a power cord. (See FIG. 7)

Module Attachment: The light module can be either attached to the rubber or metal strap by a docking base (See FIG. 6) or a standard strap connector joint (See FIG. 7).

E. Brace Configuration:

General Description: The StarLight™ “Light Brace” is a slightly larger device with a single strap adjustable fastening system. The “Laser Brace” can be used on the chest, arms, waist, and legs to treat different ailments, such as; acute injuries, wound healing, pain relief, chronic injuries and non-healing or infected wounds. (See FIG. 8)

The device is designed with a different laser, which will penetrate deeper into the skin, where blood vessels are not readily visible from surface to treat internal injuries. The unit has a large LCD displace, giving the user clear and accurate readouts. The inner padding is also of elastomer, giving the user a comfortable feel. The unit is powered either by its internal power cells or a power cord. (See FIG. 8)

Module Attachment: The light brace module can be either attached to a rubber or metal strap by a docking base (See FIG. 6) depending on the size and model or a padded brace with wither Velcro or belt fasteners (See FIG. 8).

### BRIEF DESCRIPTION OF THE SEVERAL VIEWS OF THE DRAWING

FIG. 1: Depicts the layout of the light brace model that may contain both LEDs and Laser Diodes. Both are face vertically downward to the light emission window. 1 to 12 or more LED and or Laser Diode combination maybe used. The module has a data communications port as well as a power plug port. The permanent or electric magnet can be utilized and be arranged in a donut shape around the emission window area and maybe changed through the magnet compartment cover located on bottom of the module. The diode driver, microprocessor control unit and the diodes themselves are cooled by a mini heat sink located atop the diode circuitry and transfer the excess heat to the side walls of the module.

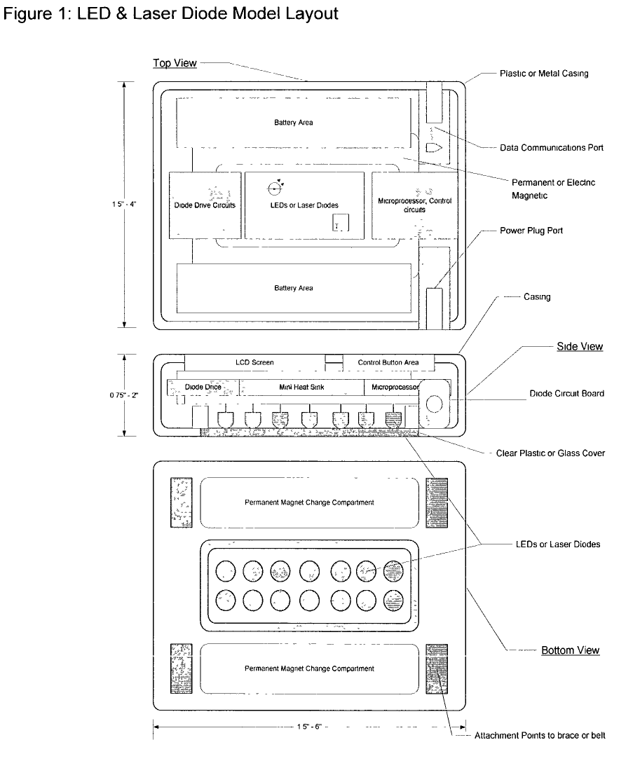

FIG. 2: Depicts the layout of laser diode light brace model. Due to the length of the laser diode, they are mounted horizontally, while an reflective prism is used to redirect the horizontal laser emission vertically downwards through the emission cover to the target treatment area. 1 to 8 or more laser diodes may be used. The module has a data communications port as well as a power plug port. The permanent or electric magnet can be utilized and be arranged in a donut shape around the emission window area and maybe changed through the magnet compartment cover located on bottom of the module. The diode driver, microprocessor control unit and the diodes themselves are cooled by a mini heat sink located atop the diode circuitry and transfer the excess heat to the side walls of the module.

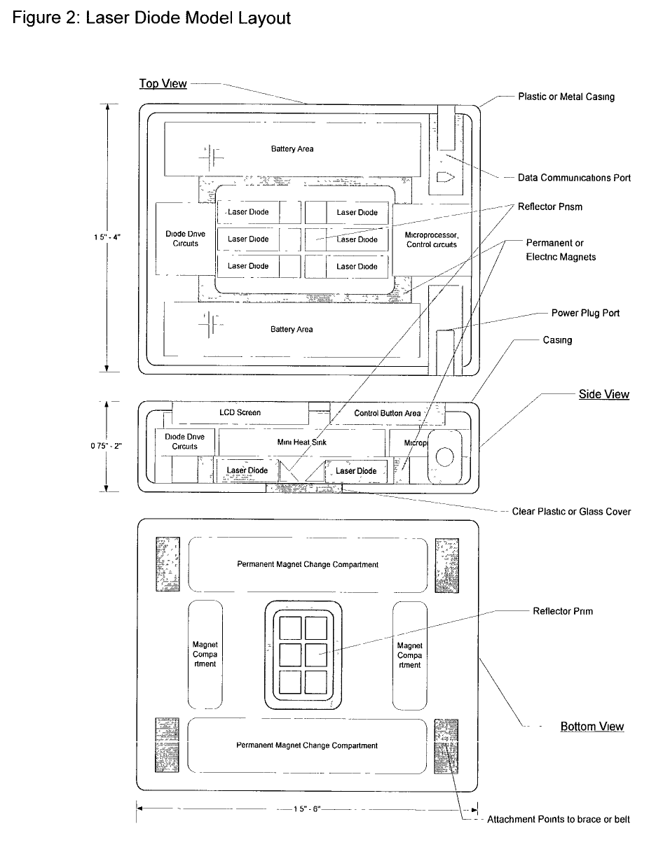

FIG. 3: Depicts the module configuration with LCD screen readout.

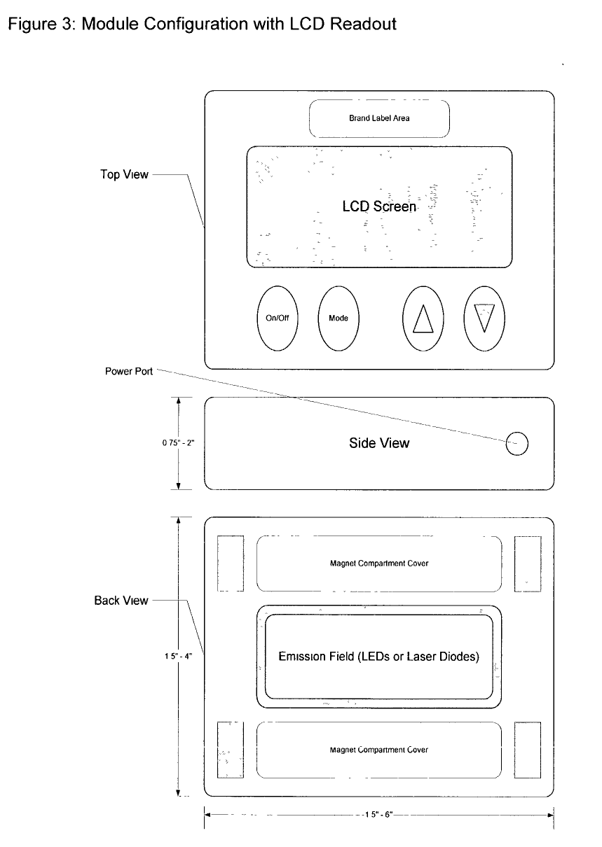

FIG. 4: Depicts the module configuration with LED screen readout.

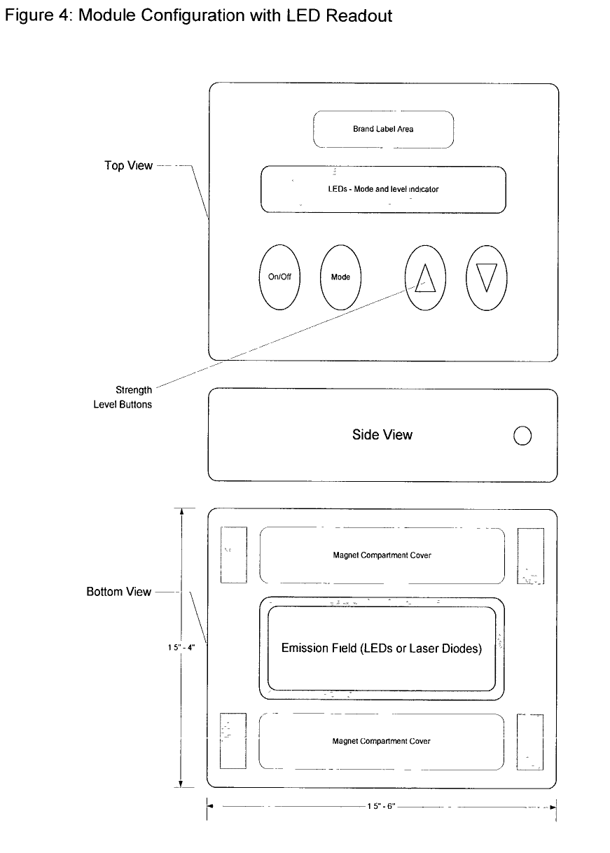

FIG. 5: Depicts the module configuration without any digital or analog readout except the power level selection button location on the top of the device.

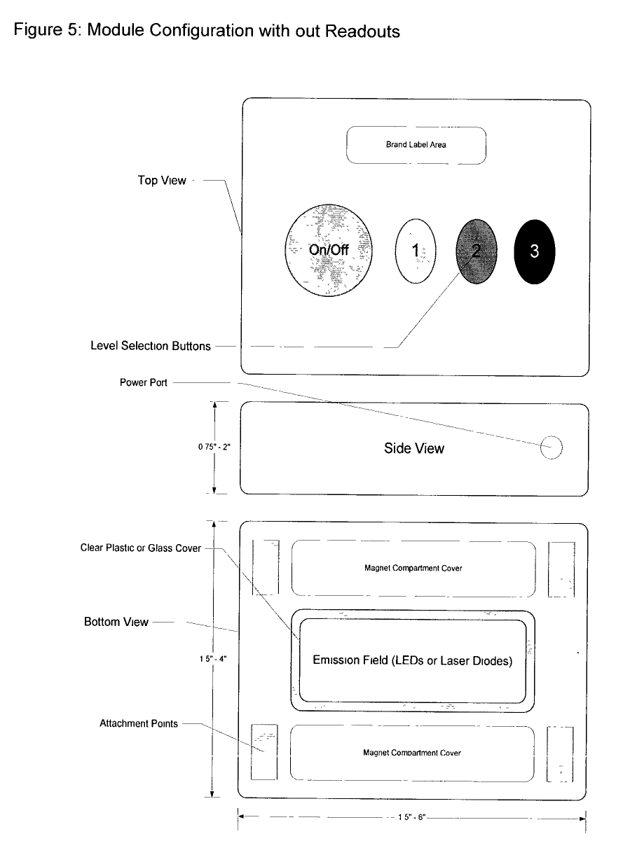

FIG. 6: Depicts a strap with a module attachment base, where the light module itself can be attached or detached from the wrist strap without unstrapping it. The module can be either clicked into the attachment base or be slide in.

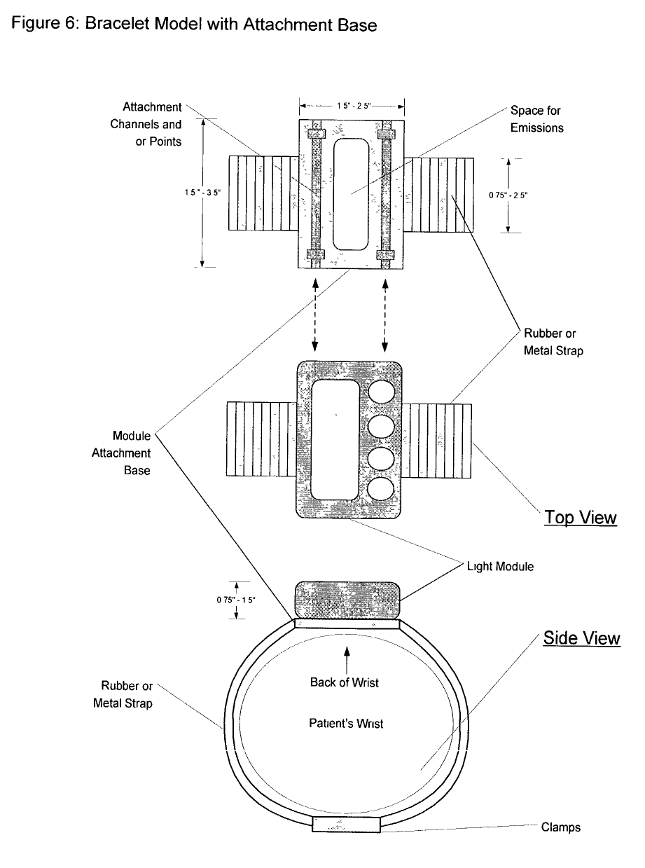

FIG. 7: Depicts a light module with a standard watch strap connector holder.

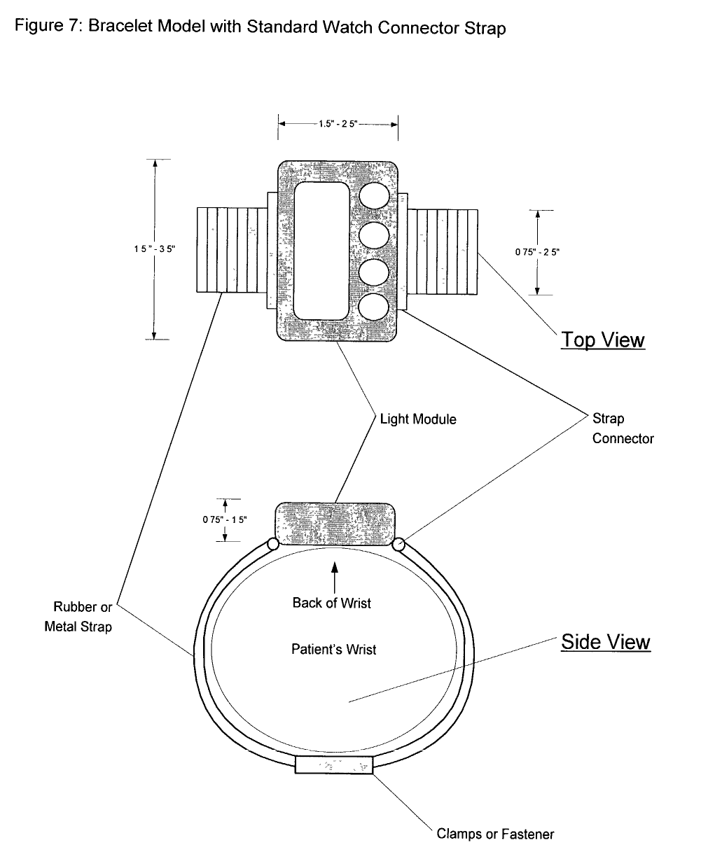

FIG. 8: Depicts the light brace model, where the portable or detachable light module is attached to the patted base with Velcro or belt straps. This device can be used on a person's wrist, arm. Leg, abdomen, or any other large area that needs treatment.

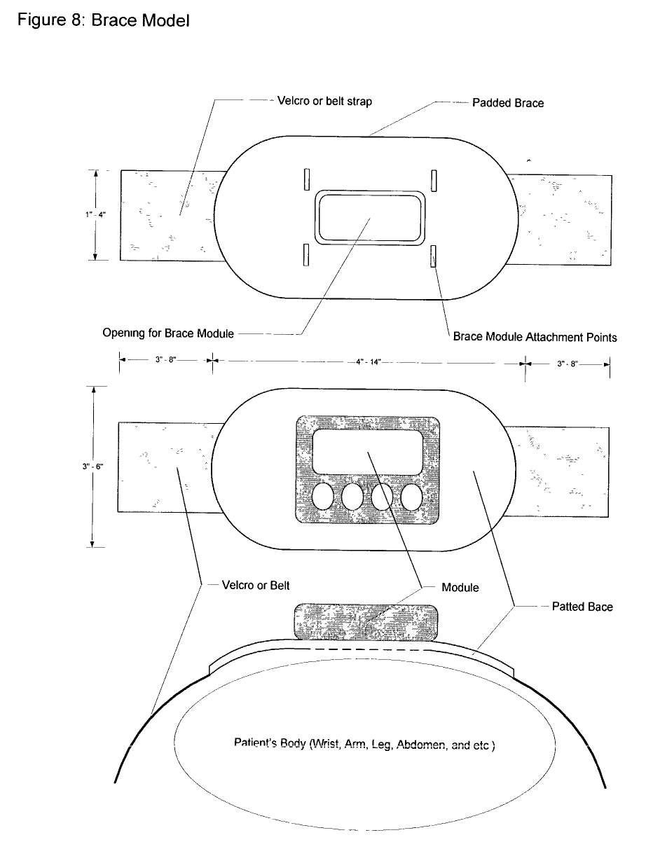

FIG. 9: Depicts the “Summary of Physiological Changes Observed After LLLT use”

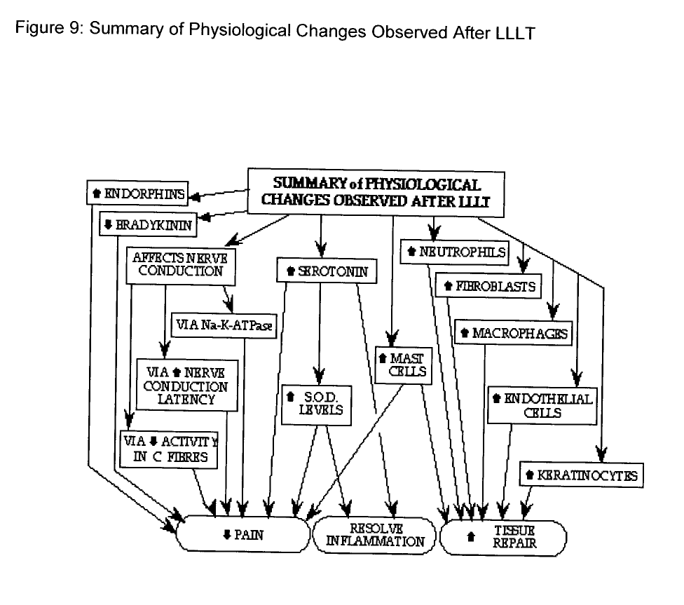

FIG. 10: Depicts the process of the physiological changes.

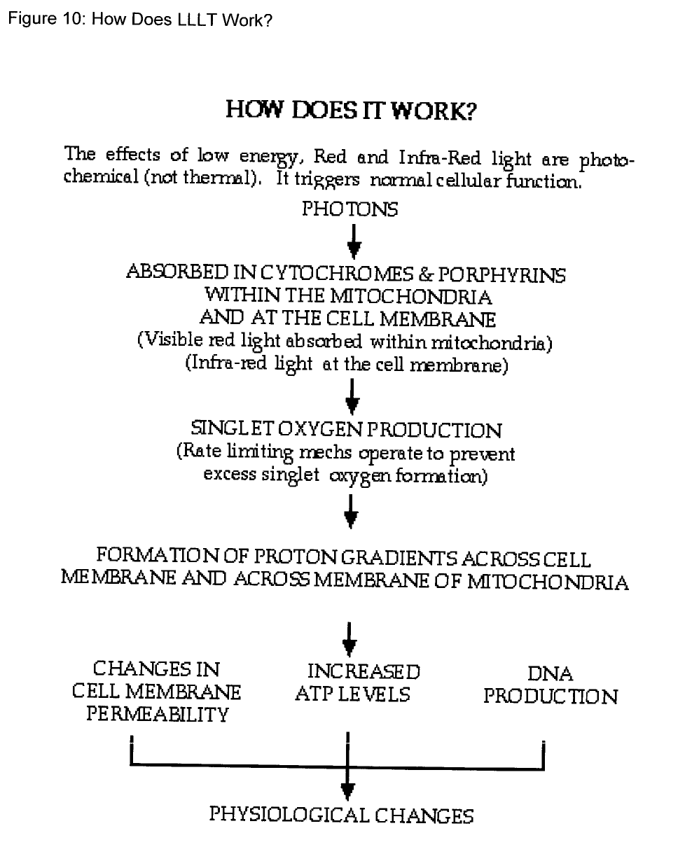

FIG. 11: Depicts the “Optical Window of the Skin” to different forms of light radiation, from UV to Infrared and beyond . . . .

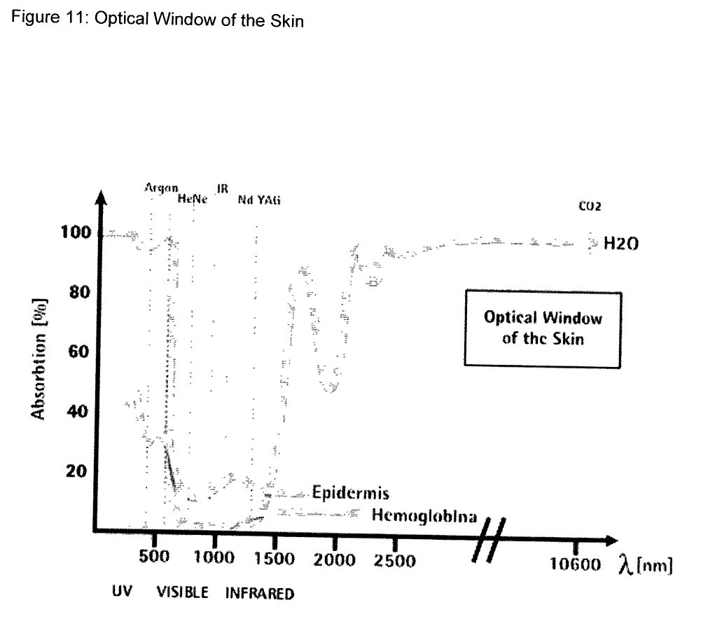

I claim:

1. It is another object, advantage, and feature of the invention that it can use both LEDs and or Laser Diodes as the light emitting source.

2. It is another object, advantage, and feature of the invention that a magnet is used in conjunction with the LED or Laser Diode to further stimulate the treatment area.

3. It is another object, advantage, and feature of the invention that the light module can be attached to straps or be mounted to an attachment base on the strap to form a wearable light bracelet.

4. It is another object, advantage, and feature of the invention that the light module can be mounted to a padded brace with straps, hence the light brace.

5. It is another object, advantage, and feature of the invention that the wave length used by the “Red Light”, either LEDs or Laser Diodes are in the range of: 620 to 675 nm.

6. It is another object, advantage, and feature of the invention that the wave length used by the “Infrared Light”, either LEDs or Laser Diodes are in the range of: 780 to 1200 nm.

7. It is another object, advantage, and feature of the invention that the power output levels of the LEDs or the Laser Diodes are in the range of: 5 mW to 1000 mW.

8. It is another object, advantage, and feature of the invention that the power density of the power levels used by either the LEDs or the Laser Diodes are in the range of: 0.05 w/cm² to >5 w/cm².

9. It is another object, advantage, and feature of the invention that the energy consumption or absorption levels are determined by a combination of wavelength, power output, pulse frequency, and treatment area or symptom.

10. It is another object, advantage, and feature of the invention that the pulsing frequency is determined by a combination of wavelength, power output, potential energy consumption, and treatment area or symptom.

11. It is another object, advantage, and feature of the invention that a LCD screen can be used to display the different readouts.

12. It is another object, advantage, and feature of the invention that a LED strength indicator can be used to display some limited readouts.

13. It is another object, advantage, and feature of the invention that the light module can be operated with a simply on/off switch along with couple power or frequency level selection buttons.

14. It is another object, advantage, and feature of the invention that the light device can be operated with or with out the use of a microprocessor or diode drive circuit.

15. It is another object, advantage, and feature of the invention that the microprocessor is programmable to control the different parameter of the light module according to the needs of the user through its on board input buttons and also through the data exchange port via a computer.

16. It is another object, advantage, and feature of the invention that the light module maybe powered by other than its onboard battery, such as by a power plug through its power plug port.

17. It is another object, advantage, and feature of the invention that the strength of the magnet, either permanent or electric should be in the following range: 800 gauss to 20,000 gauss. The electric magnet's gauss rating is adjustable via the programmable microprocessor.

18. It is another object, advantage, and feature of the invention that it is effective in managing certain types of pain.

19. It is another object, advantage, and feature of the invention that it is effective in accelerating the healing process to certain types of wound.

20. It is another object, advantage, and feature of the invention that it is effective in detoxifying certain types of toxins from the body.
